(19) United States
(12) Patent Application Publication
(10) Pub. No.: US 2014/0162702 A1
(43) Pub. Date: Jun. 12, 2014

(54) Decentralized Location Triangulation System and Data Transfer Protocol

(71) Applicants: Brandon Robert Crawford, Burlingame, CA (US); Darrell S. Mockus, San Francisco, CA (US)

(72) Inventors: Brandon Robert Crawford, Burlingame, CA (US); Darrell S. Mockus, San Francisco, CA (US)

(21) Appl. No.: 13/940,252

(22) Filed: Jul. 11, 2013

Related U.S. Application Data
(60) Provisional application No. 61/670,582, filed on Jul. 11, 2012.
(60) Provisional application No. 61/676,590, filed on Jul. 27, 2012.

(51) Int. Cl. H04W 4/02; H04W 52/02

(52) U.S. Cl. CPC H04W 4/023; H04W 52/0209
USPC 455/456.6

(57) ABSTRACT

Systems and methods for distributed location determination are disclosed. Mobile computing devices within proximity of one another can exchange signals to determine relative physical locations. Such signals include signals for determining proximity or distances that can be used by the mobile computing devices to triangulate the relative positions of the mobile computing devices. The signals can also include unique identifiers that can be used to associate a determined position with a particular mobile computing device. The mobile computing devices share their own location information and location information for other known mobile computing devices to distribute the location determination tasks. Data from stationary nodes and external positioning systems may be superimposed on the relative position determination to add external location references. The resolution of the external location references can be enhanced using the relative positions determined by the mobile computing devices.

### BACKGROUND

Unless otherwise indicated herein, the approaches described in this section are not prior art to the claims in this application and are not admitted to be prior art by inclusion in this section.

Triangulation methods can be used to calculate a location of a given object in space. By referencing known locations, the location of an object can be determined trigonometrically by determining the object's relative distance to each of the known locations. Some conventional triangulation systems use wireless signals, such as radio waves, light waves, or sound waves to measure the distances of the object from the known locations. For example, convention global positioning systems (GPS) use multiple radio waves transmitted from sub-orbital satellites and received by a device that can perform the necessary trigonometric functions to calculate its own location.

Triangulation methods have extended into the field of mobile computing. Mobile computing devices typically use various types of signals (e.g., GPS, WiFi, cellular) in combination to determine the position of the mobile computing device. Such mobile computing devices may be passive or active (i.e., receive or emit a signals) to determine its relative location relative to the known locations. While the use of active mobile devices can achieve incremental power consumption savings by off-loading the bulk of the calculation intensive operations to another device (e.g., a centralized server computer), there are still power consumption tradeoffs with respect to the power consumption associated with generating the emitted signals and executing the trigonometric calculations. As such, the power consumption savings afforded by active mobile computing device location functionality is marginal. Accordingly, the high power consumption characteristics of multiple-signal triangulation location determination techniques continues to be a drawback in battery powered mobile computing devices.

To mitigate the power consumption of such multiple-signal location systems, some devices turn off the location determination functionality whenever it is not in use. However, as technologies and services evolve, more products require constant location updates for the mobile computing device, such that turning the location determination functionality off becomes a less effective means of reducing power consumption.

### SUMMARY

Embodiments of the present disclosure include systems and methods for dynamic groups of clients, nodes, and client-nodes that receive and transmit signals, perform trigonometric calculations, store location and network data, and participate in a secondary network for communications among one another and to external services, such as a web or database server. Embodiments include any number of computing devices for a location may need be calculated (i.e., triangulated).

In one embodiment, the present disclosure includes client devices implemented in mobile devices. Such mobile devices include, but are not limited to smart phones and tablet computer. The client devices continually or at predetermined intervals (periodically or randomly) broadcast an advertisement signal. As used herein, the term advertisement signal refers to signals that include data a unique identifier by which each client device can be distinguished from other client devices. The advertisement signal may also include information regarding the state of the device. The state of the device may include accelerometer information that includes angular position and dynamic requests to be handled by the network of nodes or client-nodes.

In some embodiments, the network of nodes or client-nodes may perform any number of preparatory steps. These steps can include establishing a connection with one another for the purposes of future data exchange, automated calibration for the purposes of ascertaining distance information from each other, and utilizing external location determination or triangulation systems such as GPS to ascertain their absolute position relative to the earth. Any of the preparatory step may be completed automatically or with little user interaction.

In other embodiments, once the network of nodes is established and calibrated, when a client device comes into physical proximity of the network to detect or communicate with the nodes or client-nodes may trigger an election routine that will determine which devices in the network will perform what tasks. Accordingly, the interaction of the various devices in the network is decentralized, while reducing the consumption of energy and computational resources. In some embodiments, one of the nodes or client-nodes can be designated as the “master” for a particular client based on proximity, ID, or any other metric during an initial election process. If no node or client-node is deemed “master” may result in the initiation of election processes for the remaining nodes that can result in a new master-client relationship, thus adding redundancy and resiliency. Some embodiments designate the master as the responsible device for tasks such as coordinating triangulation efforts over a plurality of devices and responding to requests made by the client.

A client device using an altered or augmented advertisement signal, (i.e., a request) can alert the network of nodes or client-nodes that an action is required. A node designated as “master” node will respond to the client device by reading the advertisement, performing the requested action (if applicable), and returning the result to the client by establishing a temporary connection. The client acknowledges the success of the request by returning to a typical advertising state, in the client broadcast its associated unique ID.

Bi-directional data exchange can provide enhanced functionality for various use-cases. At its simplest, a client device can request any data regarding its own location. Extending that, data may be made available about other devices as observed by the network of nodes in their totality, not limited to those within physical proximity to the client device. Additionally, power consumption can be greatly reduced by limiting the requirements the network requests, that require maintaining an active network connection, establishing connections to servers, waiting for responses, etc., and thus consume power.

In other embodiments, the nodes may make network or Internet requests on behalf of the client devices, thus offloading even more power-intensive tasks to the network of nodes and only raise the power utilization of the client devices upon the successful receipt of relevant data by the nodes. In such embodiments, the “master” node may handle these requests.

In some embodiments, in addition to triangulating positions of client devices in relation to the nodes and other clients, additional operations can be performed to increase the utility information by referencing an external positioning system. The external location determination systems can be used as an external location reference for determining the position of the distributed system within a larger context. For example, the nodes can, either as a function of their installation using an external unit or as an internal capability, orient themselves using more traditional methods of triangulation such as GPS. The nodes can then superimpose the coordinates of the inherited system, such as GPS using longitude and latitude, to the triangulated client devices. Thus, the system described can extend the usefulness and granularity of services such as GPS while allowing for interoperability between such systems.

In other embodiments, clients can behave as nodes, or client-nodes. In such embodiments, the distributed nature of the system allows for efficient allocation of tasks to devices already in a high-power state by allocating “master” status dynamically. Removing the need for static nodes allows for any grouping of three or more suitably equipped client-node devices to orient themselves relative to one another. In some embodiments client-node devices can also interact with node-only devices to further augment the abilities of a network of clients as a whole by shifting energy requirements, calculation, and data transfer efforts to devices with greater access to said resources when available.

The following detailed description and accompanying drawings provide a better understanding of the nature and advantages of the present disclosure.

### BRIEF DESCRIPTION OF THE DRAWINGS

FIG. 1 is a schematic of system of nodes for location determination, according to an embodiment of the present disclosure.

FIG. 2 is a flowchart of a method for location determination, according to an embodiment of the present disclosure.

FIG. 3 is a schematic of system of nodes for location determination, according to an embodiment of the present disclosure.

FIG. 4 is a flowchart of a method for calibration of location determination systems, according to an embodiment of the present disclosure.

FIG. 5 is a flowchart of a method for location determination, according to an embodiment of the present disclosure.

FIG. 6 is a schematic of system of nodes that includes interior and exterior location determination signals, according to an embodiment of the present disclosure.

FIG. 7 is a schematic of system of nodes for peer based location determination, according to an embodiment of the present disclosure.

FIG. 8 is a schematic of computing devices and network system that can be improved by various embodiments of the present disclosure.

### DETAILED DESCRIPTION

Described herein are techniques for systems and methods for location determination systems, and in particular to indoor and outdoor peer-based location determination. In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

Conventional location systems, such as GPS, offer a “best guess” approach to triangulating position and accuracy is often limited resolutions of +/−5 meters. The resolution of GPS and other external reference location determination system is further reduced in indoor implementation due to physical obstructions of radio frequency signals originating outdoor or from outerspace. Other systems, such as WiFi triangulation, also offer a semi-accurate location data indoors but are limited by the number of available signals with which to perform a calculation and, again, require the bulk of the work involved in triangulation to happen on the object or device and thus negatively impacts energy usage and performance.

Overview

The present disclosure relates to electronic position determination systems and in particular to systems and methods for decentralized triangulation of positions of mobile devices.

Some embodiments include decentralized systems and methods for obtaining and maintaining location information. Such embodiments advantageously include robust and scalable data transfer and transformation mechanisms.

Embodiments of the present disclosure provide enhanced location triangulation system with higher location resolution, lower energy requirements, better network resiliency, and data bi-directionality. In indoor implementations of various embodiments, client devices may periodically advertise themselves using one or more wireless transmission media, such as Bluetooth LE. In some embodiments, the client devices can also act as location reference nodes for other client devices in a dynamic network. Such dynamic networks may also include nodes configured to receive the signals from the client device and other nodes used in triangulation calculations, perform the calculations required for triangulation, store the results of the calculation, and communicate with one another. The dynamic network of nodes may exchange information with each other, elect individual nodes to perform specific tasks, and recover gracefully from a failed node with no perceptible change in operation or performance.

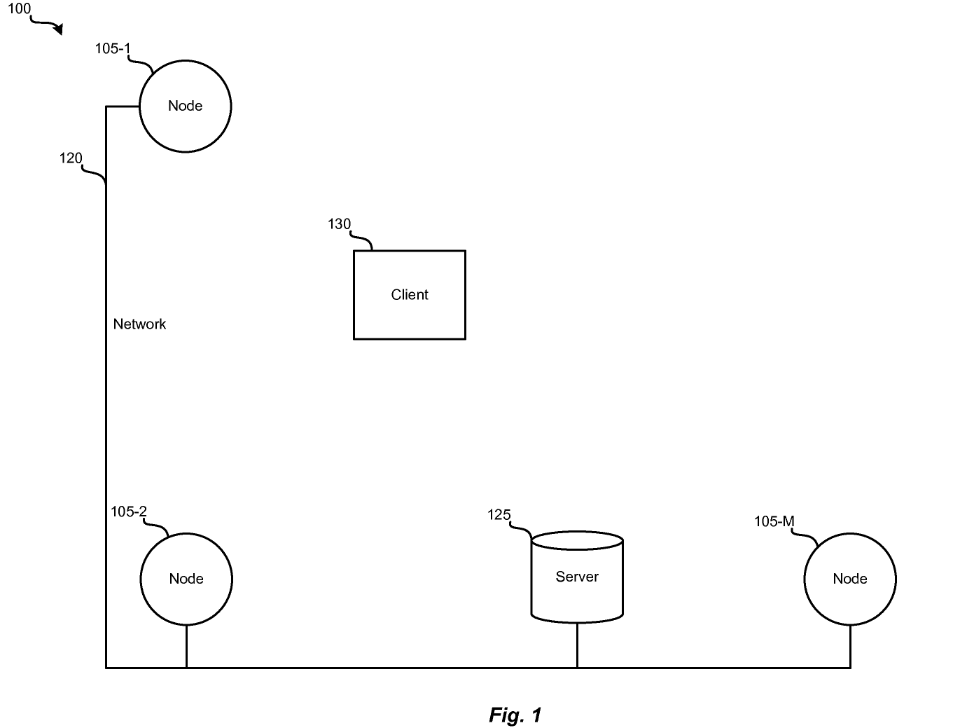

FIG. 1 is system 100 for location determination according to various embodiments of the present disclosure. System 100 may include a client 130, multiple nodes 105, and a server 125. Nodes 105 may access or communication with one another and the server 125 through the network 120.

Client 130 may include a computing device having a transmitter, a receiver, transceiver, or other devices with functionality for sending or receiving triangulation signals. For example, client 130 may send and receive signals such as, radio frequency (RF) signals, optical signals, infrared (IR) signals, ultrasonic signals, or the like. The client 130 may also include a processor and memory that can be configured to generate transmit signals and process received signals. Accordingly, client 130 may broadcast, or as often referred to herein as, “advertise”, information about the location and status the client 130 and respond to received signals.

Nodes 105 may also include transmitters, receivers, transceivers, or other devices with functionality for sending or receiving triangulation signals that a compatible with the signals of the client 130. Accordingly, the nodes 105 may also send and receive may send and receive signals such as, radio frequency (RF) signals, optical signals, infrared (IR) signals, ultrasonic signals, or the like. In addition, the node 105 may also include a processor and a memory that can be configured to generate transmit signals and process received signals. In addition, the processor may be configured to process trigonometric triangulation algorithms, perform data transformations, and process communication information sent and received over a secondary communication channel or network (e.g., IEEE 802.11x wireless networks or Ethernet).

The server 125 may include a computer system or any other resource available via the network 120. Accordingly, the server 125 may include a repository for data store for data available to the nodes 105 and the client 130. Repository may include data for the nodes 105 and/or client 130.

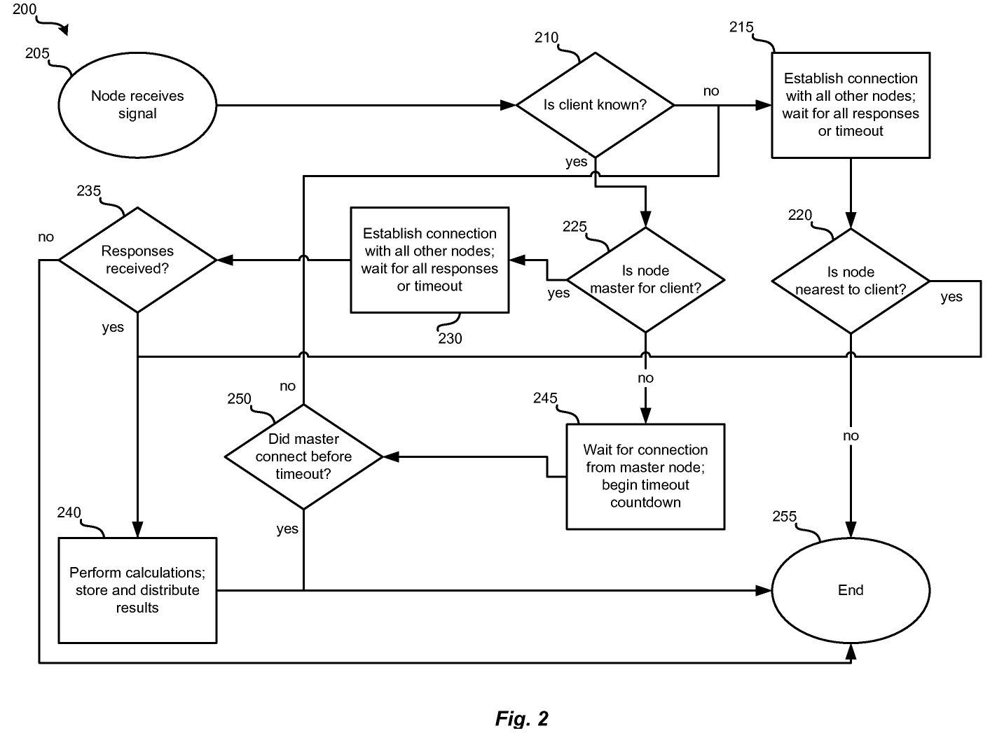

FIG. 2 is a flowchart of a method 200 for determining the location of the client 130 that is introduced into the system 100 of nodes 105 depicted in FIG. 1. Before or when the client 130 enters vicinity of nodes 105 of system 100, it can begin broadcasting and advertisement signal to be received by some or all of the nodes 105. In one embodiment, the client 130 may broadcast the advertisement signal at regular intervals. In other embodiments, the claim 130 may broadcast advertisement signal at intermittent intervals determined by a predetermined timing scheme known to the nodes 105, the client 130, and server 125. In such embodiments, the advertisement signal may include information about the client 130. For example, the advertisement signal may include a unique identifier associated with client 130.

Method 200 may begin at action 205 in which one of the nodes 105 receives and advertisement signal from the client 130. The receiving node 105, in response to first receiving advertisement signal from the client 130, can check its local records stored in a local transitory or non-transitory computer readable memory to determine if the client 130 is known, in determination 210. For example, the node 105 can check its local records to determine if it has had previous communication with the client 130. In one embodiment, determining whether the client device is known can include checking a local database stored in the receiving node 105 for a record of a previous communication associated with unique identifier of the client 130.

If, in determination 210, the receiving node 105 determines that the client 130 is unknown, the receiving node 105 may establish a connection other nodes 105 in the system 100 through the network 120, in action 215. Through the connection over the network 120, the receiving node 105 may request information from the other nodes 105 regarding the client 130 or the associated unique identifier. Accordingly, the receiving node 105 may determine from the information received from the other nodes 105 whether the client 130 identified by the received unique identifier is known to the system 100.

In some embodiments, receiving node 105 may determine whether the receiving node is the node 105 closest to the client 130, in determination 220. To determine whether the receiving node 105 is the nearest of the nodes 105 to the client 130, receiving node 205 may perform a comparative analysis of the data regarding the client 130 received from the other nodes 105. For example, the comparative analysis may include calculating metrics that describe the distance of each node 105 to the client 130. The metrics may include, but are not limited to, indications of proximity or timestamp indicators. If in determination 220, the receiving node 105 determines that it is the nearest node 105 to the client 130, the receiving node 105 may be designated as the master node. The master node, as referred to herein, is the note that collect information from all the other nodes 105, and perform the triangulation calculations in action 240. In action 240, the master node may also store the results of the triangulation calculations, and distribute the results to the other nodes 105 and server 125 in the system 100.

However, if in determination 220, the receiving node 105 determines that it is not the node 105 nearest the client 130, then the process ends for that particular node 105, at 255. In some embodiments, at 255, receiving node may return back to a “ready” state to ready itself to receive advertisement signals from the client 105 or other devices. In one embodiment, while the receiving node 105 is the ready state, no further advertisement signals from the previously recognized client device 130 will be processed. However, the receiving node 105 will be receptive to receiving new advertisement signals from newly encountered 130. Accordingly, there may be no limits to the number of clients 130 that the system 100 can handle.

Going back to the determination 210, in which the receiving node 105 determines that the client 130 from which the advertisement signal was received is known to the system 100, then at action 225, the receiving node 105 determine whether that node 105 is the master node for the client 130, at determination 225.

If the receiving node 105 determines that it is indeed the master node for the client 130, then it can establish a connection to some or all of the other nodes 105, in action 230. Establish the connection with all the other nodes 105 may include singer request for responses and waiting for the responses or a timeout period to expire. In some embodiments, the expiration of the timeout period results in the immediate and the workflow, as illustrated by the determination 235 in which the receiving node 105 determines that responses were not received before the timeout period expired. Alternatively, if responses are received from some or all of the other nodes 105, method 200 can proceed to action 240, in which the receiving node 105 performs the trigonometric triangulation calculations and distributes the results to the other nodes 105. In some embodiments, the receiving node 105 acting as the master node may also store the results in a remote or local data store. For example, the results of the trigonometric triangulation calculations may be stored in the server 125 or other external data store.

If, however, in determination 225, the receiving node 105 determines that it is not the master node 105 for the client 130, then the receiving node 105 may wait for a connection from the master node. In some embodiments, waiting for the connection from the master node may initiate a time out period countdown. In determination 250, if the receiving node 105 determines that the timeout period expired before the master node connects, then the method 200 may end at 255. Alternatively, if the receiving node 105 determines that the timeout period has not expired, then the method 200 may proceed to action 215, in which the receiving node 105 may determine an alternate master node. Receiving a successful connection from the master node may trigger receiving node 105 to send any data it may have regarding the client 130 to the master node.

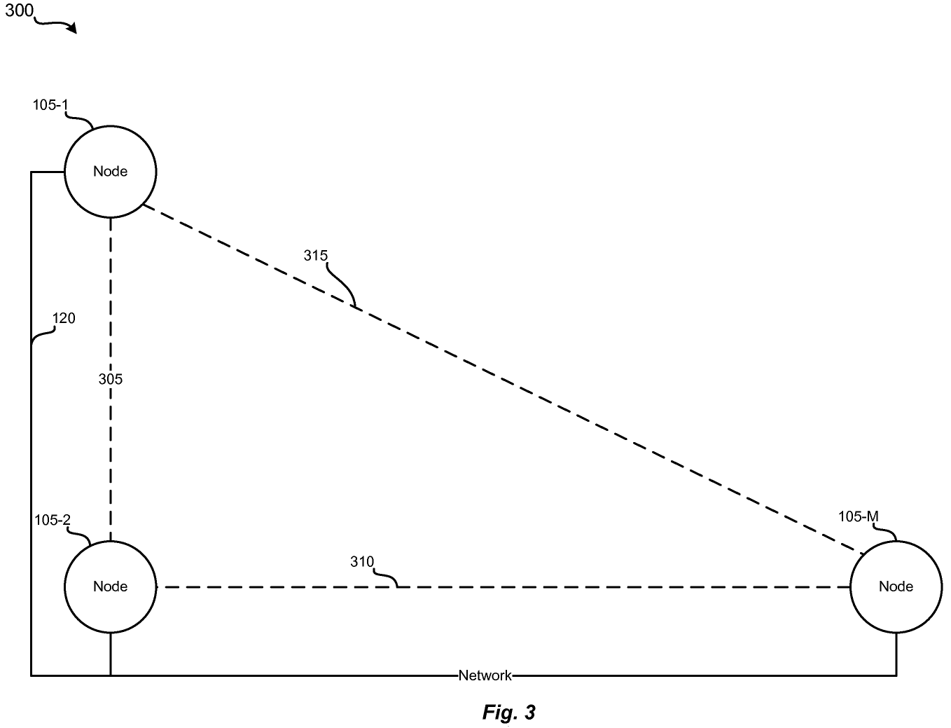

FIG. 3 illustrates determination of the geometry 300 of the system 100 used in the trigonometric triangulation calculations of various embodiments of the present disclosure. FIG. 3 illustrates the known distances 305, 310, and 315 between the nodes 105 as shown. Because the precise distances 305, 310, and 315 are needed for the precise determination of the location of the client 130, various embodiments the present disclosure provides for the periodic calibration of the distances. In some embodiments, the calibration of the distances may also include periodically calibrating the noise to signal ratio within the system 100 to account for any possible shifts in the noise floor. For example, changes in the number of clients 130 within the system 100 may contribute to the decrease in the signal-to-noise ratio.

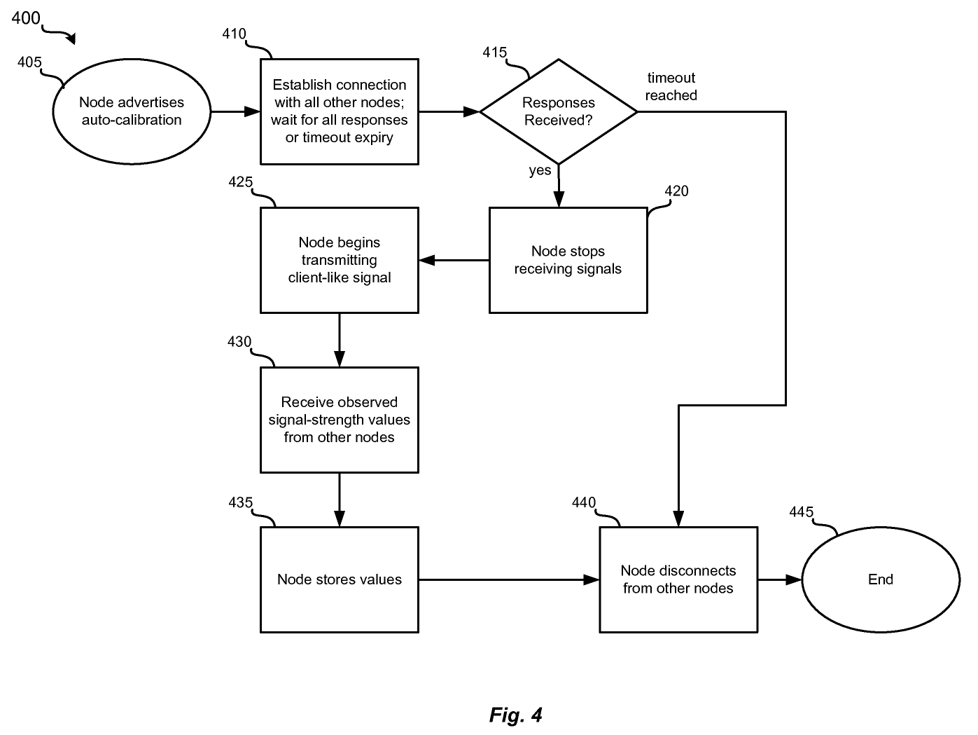

FIG. 4 is a flowchart of a method 400 for calibrating the system 100, according to an embodiment of the present disclosure. The method 400 may begin at action 405 in which one of the nodes 105 advertises or broadcasts the activation of a calibration process. The activation of a calibration process may be informative (i.e., alerting other nodes 105 that the calibrating node 105 may be off line 4), or the activation of the calibration process may be a command to other nodes 105 to also initiate a calibration process. The node 105 that initiates the calibration process is referred to herein as the initiating node.

In action 410, initiating node attempts to establish connections with some or all of the other nodes in the system 100 through the network 120. Establishing the connection with the other nodes may include sending a request for connections and waiting for a response. The initiating node may wait for responses from some or all of the other nodes 105 for a predetermined timeout period. If in determination 415, the initiating node does not receive any responses before the timeout period expires, the receiving node may disconnect from the other nodes 105 in action 440 and returns to normal operation at 445. However, if in determination 415, the initiating node receives responses from some or all the other nodes 105 before the expiration of the timeout period, then the initiating node stops waiting and begins the rest of the auto calibration process.

In one embodiment, the initiating node may begin transmitting like it were a client 130, and action 425. The other nodes 105, while still connected to initiating node through the network 120, may receive the signals transmitted by the initiating node and return information about the received signals to the initiating node through the network 120. Initiating node may receive the information about its transmitted signals from the other nodes, in action 430. For example, the other nodes may return information regarding the transmission strength of the signal, signal-to-noise ratios, and other signal processing information. The initiating node can store the return values from the other nodes 105, in action 435, to use in calibration calculations. Initiating node may then disconnect from all the other nodes, in action 440.

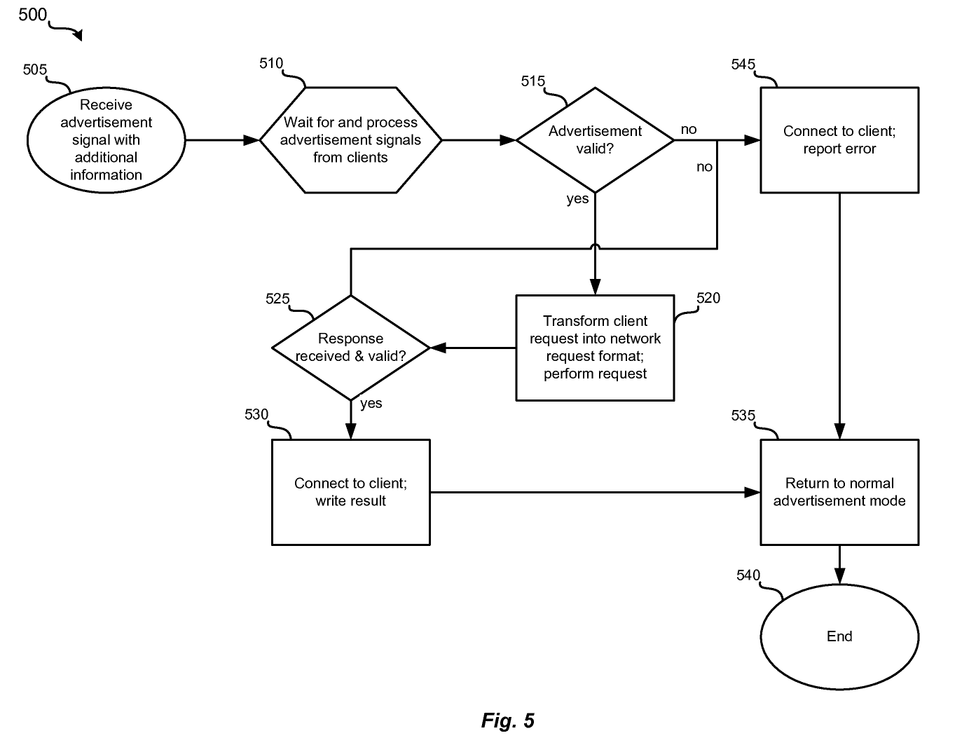

FIG. 5 is a flowchart of a method 500 for the exchange of data among the nodes 105 in system 100. In some embodiments, the method 500 may occur in parallel with the performance of the trigonometric triangulation calculations performed by a node 105 in action 240 of method 200 illustrated in FIG. 2. In some embodiments, method 500 is initiated by the receipt of an advertisement signal that includes the indication of a request is received from a client 130 at one or more of the nodes 105. The request may indicate a particular action or function to be initiated by the nodes 105.

In action 510, a node 105 may wait for an process advertisement signals from clients 130 as described in reference to method 200 of FIG. 2. In determination 515, the node 105 can determine whether the received advertisement signal is valid. In some embodiments, determining whether the received advertisement signal is valid includes determining whether the advertisement signal includes a request for an action or function of the node 105 can perform. If in determination 515, the node 105 determines that the advertisement signal is not valid or includes a request for a function that cannot be performed by the node 105, then the node 105 may send the client 130 an error message, in action 445. Sending the error message from the node 105 to the client 130 may include establishing an electronic communication connection and sending a predetermined error code. Once the error code is sentenced to the client 130, the node 105 and the client 130 may resume normal activity. In some embodiments, the normal activity may include the client 130 sending regular advertisement signals, and the node 105 receiving such signals.

If however, in determination 515, the node 105 determines that the request is valid, then the node 105 may initiate operations to perform the requested action. Specifically, in action 520, the node 105 may transform the request from the client 130 into a format compatible with the network 120 or other external services (i.e., Web services or database server). Alternatively, the node 105 may respond directly to the requesting client 130. For requests of the node 105 forms and sentenced to an external service, such as the server 125 or another node 105, in action 525 the node 105 can determine whether not a response is received and valid in determination 525. If the responses received and valid, then the node 105 may transform and transmit the response to the client 130. If no response is received or the response is invalid, then the node 105 may report an error message to the client in action 545.

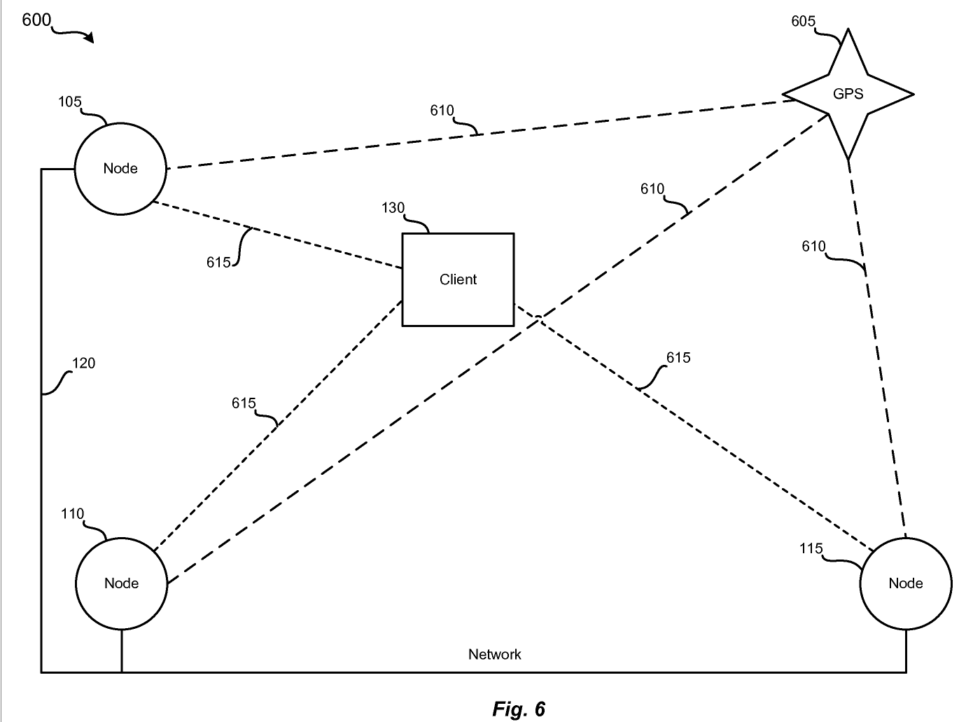

FIG. 6 is a schematic of a system 600 that is similar to system 100 of FIG. 1 with the addition of a global positioning satellite (GPS). Each of the nodes 105 may be connected to one another through the network 120. In addition, each of the nodes 105 may include a receiver for receiving signals 610 from the GPS. Accordingly, signals from the GPS can be used to determine location of each node 105.

Conventional systems, like GPS, offer an approximation to triangulating position, therefore the accuracy of such systems is often limited to a resolution of approximately ±5 meters. The accuracy of such system is further reduced for indoor applications were clear line of sight to the GPS satellites is often obstructed, the resolution of the GPS RF signals is diminished. Some systems exclusively use wireless networking signals (e.g., 802.11x) as triangulation signals. Embodiments of the present disclosure offer clear advantages over such systems because the ability to share proximity and location information among multiple clients, increases the available location data and thus increase possible location determination resolution, while also reducing power consumption by sharing the calculation workload across more computing device. Each computing device acting at the client or the client-node in embodiments need only perform a fraction of the trigonometric triangulation calculations.

Embodiments of the present disclosure provide higher resolution location triangulation systems for use in both indoor, outdoor, and ad hoc scenarios in which fewer than all clients 130 know their location. Other advantages of the present disclosure include lower energy consumption, better network resiliency, and bi-directional data exchange. To increase accuracy indoors, clients 130 periodically advertise using one or more types of signals. In some embodiments, clients 130 may use Bluetooth LE signals to broadcast and receive advertisement and signals and triangulation signals. Some embodiments include a dynamic network of nodes or client-nodes that receive signals used in triangulation, perform the calculations required for triangulation, store the results of the calculation, and communicate with other nodes or client-nodes in the dynamic network. As used herein, the term dynamic network refers to a network of nodes or client-nodes that link to one another as needed when in proximity to one another. The dynamic network of nodes or client-nodes may exchange information with each other, elect individual nodes to perform specific tasks, and recover from the inclusion of a failed node with no perceptible change in operation or performance by the user.

In other embodiments, each nodes or client-node may transmit the triangulation signal and the data/synchronization signals using the same communication medium or protocol (e.g., Bluetooth, 802.11x, IR signals, optical, sonic, etc.) such that any client, node, or client-node for which a location has been triangulated may request the results of said triangulation, thus further reducing the energy consumption and allowing for bi-directionality of data.

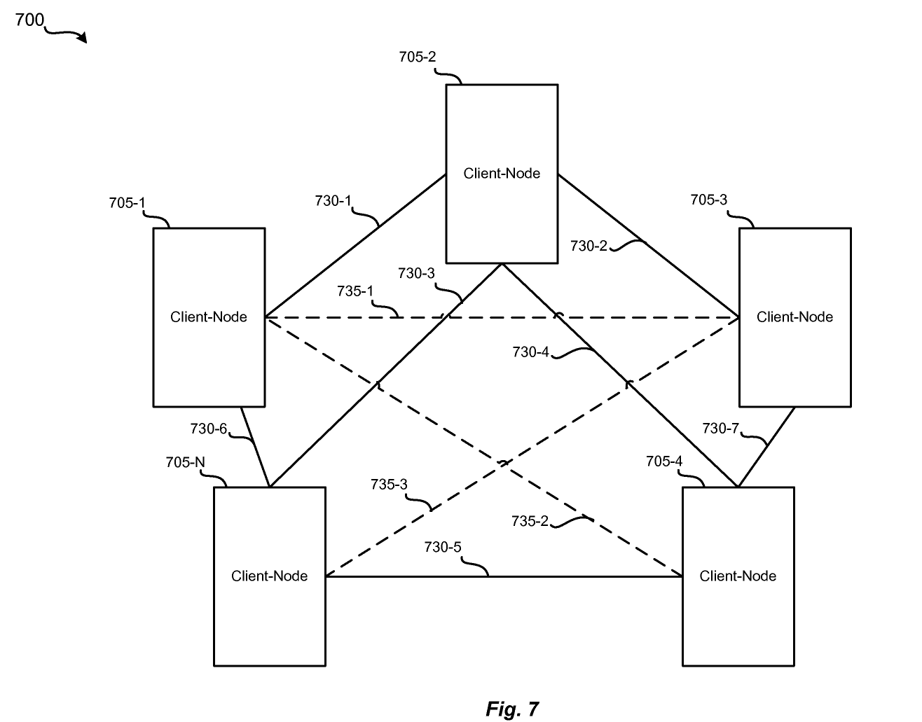

FIG. 7 is a schematic of a peer based location determination system 700. As shown, each of the N client-nodes 705, wherein N is a natural number, may include components of the nodes 105 and/or client 130 described herein. Accordingly, each client-node 705 may perform the functionality of the nodes 105 or the client 130 simultaneously or in alternating intervals. For example, client-nodes 705 may include a mobile computing device, such as a smartphone, tablet computer, and the like, that can send, receive, and process triangulation signals. The signals may include, but are not limited to, RF signals, IR signals, optical signals, and sonic signals. The triangulation signals may include independent signals that are dedicated to purpose of location determination. In some embodiments, the triangulation signals may be included in other communication signals that the client-node 705 send and receive. In either independent or combined triangulation signals, the triangulation signals may be incorporated into or embedded into cellular voice or data signals, wireless networking signals, and close proximity data connection signals (e.g., Bluetooth).

In any given configuration of client-nodes 705, some of the client-nodes 705 may or may not be able to receive triangulation signals from some or all of the other client-nodes. For example, as illustrated in FIG. 7, client-nodes 705 pairs connected by solid-line connections 730 represent client-nodes 705 that are sufficiently close such that they may exchange triangulation signals with one another, while the client-node 705 pairs connected with dotted-line connections 735 are separated in space to the extent that they cannot exchange triangulation signals. The triangulation signals may include both the inter client-node 705 communication signals (i.e., data signals used for communicating and calibration) and the triangulation signals (i.e., proximity and timing signals).

The client-nodes 705 may perform the various methods of triangulation, calibration, and data exchange described herein in reference to FIGS. 2, 4, 5, and 6. In addition, the client-nodes 705 may also receive triangulation signals from an external system, such as a GPS satellite. The signals from the external system can be used by the client-nodes 705 to directly describe the location of the client-node 705 and also to describe any client-node 705 not capable of locating itself, either because of lacking of suitable equipment or being unable to receive a viable signal.

Each client-node 705 may request data and respond to requests for data from other client-nodes 705. In some embodiments, each client-node 705 may periodically receive a list of currently-visible nodes from other client-nodes 705 or nodes 105 to which it has access. For instance, in the scenario shown in FIG. 7, client-node 705-1 has access to and is able to connect to client-nodes 705-2 and 705-N. Client-node 705-1 cannot, however, access client-nodes 705-3 or 705-4. A request made from client-node 705-1 to client-node 705-2 would reveal status, position, and proximity information about client-nodes 705-3, 705-4, and 705-N from the perspective of client-node 705-2. Further, a request for information sent to client-node 705-4 would reveal information about client-nodes 705-2, 705-3, and 705-N.

In some embodiments, information determined from the signals from an external source and/or the information obtained by each of client-nodes 705 from one another, can be used by each client-node 705 to form an accurate representation of the physical and geo-spatial layout of all client-nodes 705 at any given moment in time. For instance, because client-node 705-2 has direct access to every other client-node 705 depicted, it can use information received from all the other client-nodes 705 to generate a relative location diagram, such as the one depicted in in FIG. 7. Client-node 705-N has information about the distance from itself to client-node 705-1 as well as client-node 705-4. Client-node 705-3 has information about the distance from itself to client-nodes 705-2 and 05-4. Knowing all possible connections and all impossible connections allows for accurate calculation wherein a diagram like the example depicted in FIG. 7 can be drawn automatically by the client-nodes 705.

In some embodiments, client-nodes 705 can operate in client-mode, node-mode, or client-node mode.

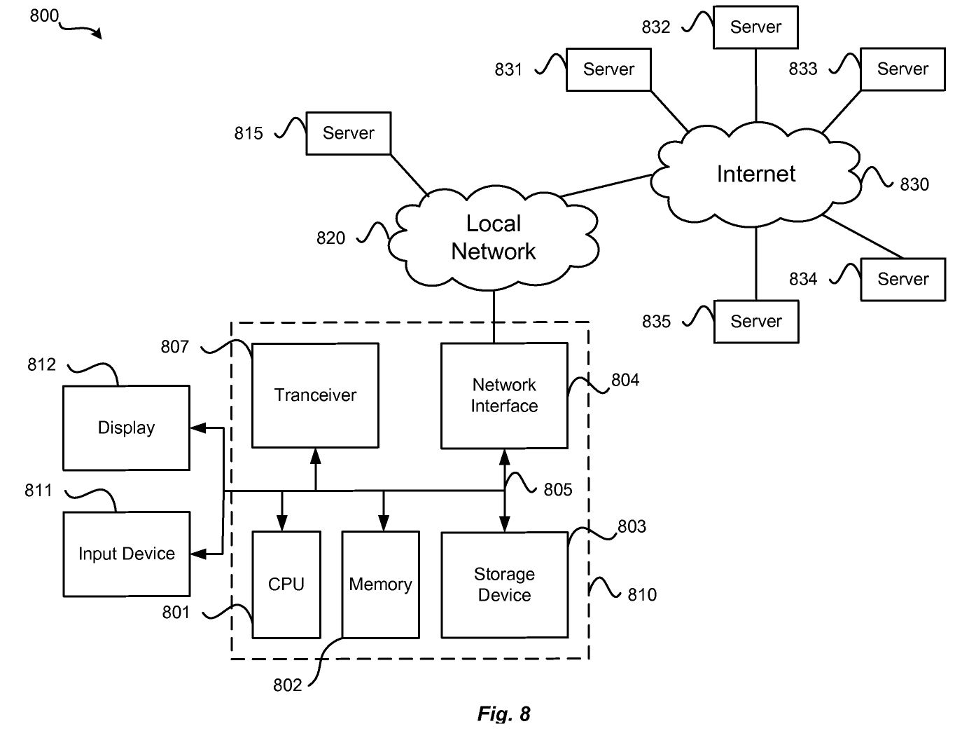

FIG. 8 illustrates an example computing device and network that may be used to implement one embodiment of the present disclosure. Computing device 810 includes a bus 805 or other communication mechanism for communicating information, and a processor 801 coupled with bus 805 for processing information. Computing device 810 also includes a memory 802 coupled to bus 805 for storing information and instructions to be executed by processor 801, including instructions for performing the techniques described above. This memory may also be used for storing temporary variables or other intermediate information during execution of instructions to be executed by processor 801. Possible implementations of this memory may be, but are not limited to, random access memory (RAM), read only memory (ROM), or both. A storage device 803 is also provided for storing information and instructions. The information instructions can be in the form of computer readable code stored on the storage device, accessible and executable by processor to implement various techniques and methods of the present disclosure. Common forms of storage devices include non-transient, non-volatile computer readable media, for example, a hard drive, a magnetic disk, an optical disk, a CD, a DVD, a flash memory, a USB memory card, or any other medium from which a computer can read.

Computing device 810 may be coupled via the same or different information bus, such as bus 805, to a display 812, such as a cathode ray tube (CRT), touchscreen, or liquid crystal display (LCD), for displaying information. An input device 811 such as a keyboard and/or mouse is coupled to a bus for communicating information and command selections from the user to processor 801. The combination of these components allows the user to communicate with the system.

The transceiver 807 may include one or more transmitters or receivers for sending and receiving communication and triangulation signals. As used herein, triangulation signals may include any signal that can be used to determine proximity or distance of one computing device to another. According, the triangulation signals may include RF signals, optical signals, IR signals, sonic signals, and the like. The transceiver 807 can transmit signals generated by the CPU 801 and relay received signals to the CPU 807 for processing or location determination. In some embodiments, location determination may include performing triangulation calculations.

Computing device 810 also includes a network interface 804 coupled with bus 805. Network interface 804 may provide two-way data communication between computing device 810 and the local network 820. The network interface 804 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 804 sends and receives electrical, electromagnetic, or optical signals that carry digital data streams representing various types of information.

Computer system 810 can send and receive information, including messages or other interface actions, through the network interface 804 to an Intranet or the Internet 830. In the Internet example, software components or services may reside on multiple different computer systems 810 or servers 831 across the network. Software components described above may be implemented on one or more servers. A server 831 may transmit messages from one component, through Internet 830, local network 820, and network interface 804 to a component or container on computer system 810, for example. Software components of a composite application may be implemented on the same system as other components, or on a different machine than other software components. This process of sending and receiving information between software components or one or more containers may be applied to communication between computer system 810 and any of the servers 831 to 835 in either direction. It may also be applied to communication between any two servers 831 to 835.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A system comprising:
a plurality of mobile computing devices, wherein each mobile computing device comprises:
a mobile processor;
a transceiver coupled to the mobile processor, and
a non-transitory computer readable memory coupled to the mobile processor and comprising:
a unique identifier associated with the mobile computing device; and
executable code that when executed by the mobile processor causes the mobile processor to be configured to transmit the unique identifier using the transceiver of the mobile computing device; and
a plurality of nodes, wherein each node is coupled to at least some of the plurality of other nodes through a network, and wherein each node comprises:
a processor;
a transceiver coupled to the processor; and
a memory coupled to the processor and comprising:
a location data associated with the node; and
executable code that when executed by the mobile processor causes the mobile processor to be configured to receive signals comprising unique identifiers from the plurality of mobile computing devices and to send, in response to the unique identifiers, signals comprising the location data to the mobile computing devices.
